(19) United States
(12) Patent Application Publication
(10) Pub. No.: US 2024/0344856 A1
(43) Pub. Date: Oct. 17, 2024

(54) FLOWMETER FOR TWO-PHASE FLUID

(71) Applicant: L'Air Liquide, Société Anonyme pour I'Etude et I'Etude et I'Exploitation des Procédés Georges Claude, Paris (FR)

(72) Inventors: Didier PATHIER, Voisins le Bretonneux (FR); Christian REYMONO, Montmorency (FR); Antony DALLAIS, Janvry (FR); Vincent ALATERRE, Paris (FR)

(21) Appl. No.: 18/294,475

(22) PCT Filed: Jul. 7, 2022
(86) PCT No.: PCT/EP2022/068873

§ 371 Date: Feb. 1, 2024

(30) Foreign Application Priority Data
Aug. 3, 2021 (FR) FR108428

(51) Int. Cl. G01F 1/50; G01F 23/14

(52) U.S. Cl. CPC G01F 1/50; G01F 23/14

(57) ABSTRACT

A flowmeter for liquid/gas cryogenic two-phase fluids, comprising an inlet pipe having a calibrated orifice, a vertical reservoir surrounded by an apparatus and having a wall with a plurality of slots for outflow of the two-phase fluid, thereby forming a spillway system. At least one pressure sensor configured to measure the pressure difference between the bottom of the vertical reservoir and an atmosphere surrounding the vertical reservoir, the pressure difference between two points in the space surrounding the vertical reservoir within the interior space, thereby deducing the height of liquid downstream of the vertical reservoir, thereby determining the state of the two-phase fluid and determining a level of liquid flooding downstream of the vertical reservoir, and a third pressure difference between upstream and downstream of the calibrated orifice. A data acquisition and processing system, configured to determine the state of the incoming two-phase fluid and determining a flow rate.

### CROSS REFERENCE TO RELATED APPLICATIONS

This application is a 371 of International Application No. PCT/EP2022/068873, filed Jul. 7, 2022, which claims priority to French Patent Application No. 2108428, filed Aug. 3, 2021, the entire contents of which are incorporated herein by reference.

### BACKGROUND

The present invention relates to the field of flowmeters for gas/liquid two-phase cryogenic fluids.

Measuring the flow rate of a two-phase fluid made up of a liquid and a gas is a difficult operation when it is desired to measure a mass flow rate. Specifically, all the sensors measuring a flow rate are hindered when they are placed in the presence of a two-phase liquid of which the density changes at any time. This is valid in particular for measuring the flow rate of cryogenic fluids such as liquid nitrogen.

Some flowmeters identified in the literature are based on the measurement of the velocity of the fluid. These are, for example:
turbine flowmeters: a turbine is installed in the moving fluid and the speed of rotation of the turbine gives a picture of the velocity of the fluid.
Pitot tube flowmeters: two tubes are installed in the moving fluid to be measured. One tube is installed perpendicular to the flow and gives the static pressure, the other is installed parallel to the flow and gives the total dynamic pressure. The dynamic pressure difference between these two measurements makes it possible to calculate the flow rate.
ultrasonic flowmeters: some use the Doppler effect (analysis of the frequency reflected by the particles of the fluid, which gives a picture of the velocity of the particle and therefore of the fluid) while others measure a difference in travel time of an ultrasonic wave from upstream to downstream and from downstream to upstream (picture of the velocity of the fluid).

In all these cases, when the density of the fluid varies continuously, the change from the volume flow rate to the mass flow rate is tricky to carry out accurately.

Other systems use the measurement of head loss (pressure loss) to deduce the flow rate therefrom. These are for example calibrated orifice flowmeters, which measure the head loss upstream and downstream of a calibrated orifice placed in the moving fluid. The measurement of these devices is severely disturbed when the fluid does not have a constant density and when the content of gas increases in the liquid.

Electromagnetic flowmeters, applicable only to fluids having sufficient electrical conductivity, use the principle of electromagnetic induction: An electromagnetic field is applied to the fluid and the electromotive force created (force proportional to the flow rate of the fluid) is measured. In the case of measuring flow rate of (non-conductive) cryogenic fluids such as liquid nitrogen, this principle is not applicable.

Vortex flowmeters are based on the phenomenon of generation of vortices that are observed behind a bluff fixed body placed in a moving fluid (Karman effect). Measuring the pressure variations created by these vortices gives the frequency of the vortices, this being proportional to the velocity of the fluid when the fluid retains constant properties. When the density of the fluid varies, the measurement is distorted.

Thermal flowmeters are those based on measuring the temperature increase created by a constant supply of energy. A system with two temperature probes measures the temperature difference between the flow entering and leaving the flowmeter. Between these two probes, a resistor provides a known quantity of energy. When the heat capacity of the moving fluid is known, the flow rate can be calculated from these measurements. However, this principle is not applicable to two-phase liquids of which the thermal behavior (vaporization of the liquid) is totally different from single-phase liquids.

Only the Coriolis mass flowmeter gives an accurate measurement of the mass flow rate of a fluid. The flowmeter is constituted of a U- or omega-shaped or curved tube, in which the fluid circulates. The U is subjected to a lateral oscillation and the measurement of the phase shift of the vibrations between the two legs of the U gives a picture of the mass flow rate. However, its cost is quite high and when it is used at very low temperatures (liquid nitrogen at −196° C. for example) and with a fluid of which the density varies greatly and having a large part in the gaseous phase, it is necessary to insulate the system considerably (efficient insulation such as vacuum insulation for example) and, nevertheless, the measurements are distorted when the gas content exceeds a few percent by mass. It will also be noted that the measurement is often made impossible when the velocity of the fluid is low or zero (in the first half of the measurement range).

As can be observed, the measurement of the flow rate of a two-phase liquid and in particular the measurement of the flow rate of a cryogenic fluid with acceptable accuracy is not easy to carry out with the apparatuses currently available on the market.

It may nevertheless be noted that systems are currently sold.

Mention may be made for example of the case of systems based on the principle of measuring the level of a liquid flowing in a channel just before a restriction of the flow cross section. This system, described in document U.S. Pat. No. 5,679,905, operates essentially as follows: the two-phase fluid is first separated into a gaseous phase that is not measured and a liquid phase of which the flow rate is measured. This liquid passes into a channel which has a reduction in cross section at its outlet. The higher the flow rate, the higher the level of liquid in the channel and a level measurement in this channel then makes it possible to deduce the instantaneous flow rate. As is observed, this system does not take into account the gaseous flow rate, which in certain applications is negligible. By contrast, this system makes it possible to measure, with relatively good accuracy, the flow rate of liquid without being disturbed by the gas content, and this is the desired aim.

It will be noted in passing that in order for this system to operate correctly, it has to be well insulated from the ingress of heat that could vaporize a part of the insulated liquid and thus disturb the level measurement. This is why vacuum insulation is used in this system.

It will also be noted that, in order for the system to operate, two phases have to be present in the flowmeter, and this prevents it from operating with a subcooled liquid (pure liquid without a gaseous phase).

It may also be noted that this document implements a V-shaped slot, which has the drawback of being difficult to produce with great accuracy. A variation of 5% over the width of the slot has very serious consequences because it makes the measurement inaccurate in the same proportions.

Mention may also be made of the case of phase separator flowmeters.

Specifically, in the case in which the measurement of the liquid and gas flow rates is necessary, a system is sometimes used that adopts the same principle of separation of the phases before the flow rate measurement.

Thus, commercially available apparatuses have the following device:
The two-phase liquid first passes into a phase separator that separates the liquid phase from the gaseous phase;
The gaseous phase is directed toward a volumetric flowmeter (of turbine type for example) with temperature compensation;
The liquid phase is also directed toward a volumetric flowmeter (of turbine type for example);
These two flow rate measurements are then converted into a mass measurement and added.

A priori, this device is more expensive than the previous one; it may be thought that it will be very accurate. In practice, it is observed that the measurement of the liquid flow rate is marred by errors that fluctuate depending on the pressure and temperature conditions of the liquid entering the flowmeter. These measurement errors are due to the presence of gas in the liquid phase that passes through the flowmeter. Specifically, when the liquid leaves the phase separator to go toward the flowmeter, a liquid part is vaporized, either because of the ingress of heat or because of the pressure drop due to a rise of the liquid, or because of a pressure drop due to the head loss created by the flowmeter itself.

Finally, in order to measure the flow rate of a cryogenic liquid, it is also possible to overcome the problems mentioned above by creating pressure and temperature conditions different from the equilibrium pressure (boiling range). In this field, the most commonly used method is for example a flowmeter at the outlet of a cryogenic pump (high-pressure side). In this case, the liquid is for example pumped into a tank where it is at equilibrium and the pressure thereof is increased by the pump, this being done almost without an increase in temperature. The pipework and the flowmeter that follow can then create a head loss; this will not have the consequence of vaporizing the liquid provided that the head loss is markedly lower than the pressure increase created by the pump.

In this case, it is possible to use a conventional flowmeter of the vortex or turbine type or of another type insofar as it withstands low temperatures.

This technique is for example perfectly suited to the flow rate measurement of nitrogen delivery trucks. It is reliable and of an acceptable cost insofar as the cryogenic pump is required for other reasons.

By contrast, when it is necessary to measure the flow rate of liquid nitrogen at a point where there is no cryogenic pump, then this technique is no longer advantageous.

A solution for simultaneous or alternating measurement of the liquid and gaseous phases is also known, as described in the document FR-3 013 446 in the name of the applicant, which is based on the following principle:
the fluid arrives in a tank acting as phase separator;
the gaseous phase is evacuated via the top of the tank, passing through a flowmeter operating on a pure gaseous phase;
the liquid phase is evacuated via the bottom of the tank, passing through a flowmeter operating on a pure liquid phase;
the two phases are then combined at a three-way valve and continue their path;
provided with the two measured flow rates and the pressure and temperature of the fluid, the system can calculate the mass flow rate of the fluid passing through the flowmeter.

This system proves to be accurate and operates regardless of the content of two-phase present in the fluid. It operates accurately when the fluid is totally gaseous or when it is totally liquid or subcooled, but it also operates in all intermediate situations.

However, this system is penalized by the fact that it is relatively expensive and that its installation is relatively complex.

It has to be installed horizontally and its bulk is quite large (typically 1 meter wide, 1 meter long, 2 meters tall).

### SUMMARY

The present invention therefore seeks to propose a novel, simple and reliable solution for measuring the flow rate of cryogenic gas/liquid two-phase fluids, making it possible to solve all or some of the technical problems mentioned above.

As will be seen in more detail below, the solution proposed here is based on the implementation of the following measurements:
1. Measurement of the flow rate of the non-subcooled liquid phase using a spillway system: a measurement of the flow rate of the non-subcooled liquid phase with what is known as a “spillway” system. To this end, the two-phase fluid is first separated naturally into a gaseous phase that is not measured and a liquid phase of which the flow rate is measured.

The principle of the spillway is as follows: An obstacle (partition perforated with one or more slots) is installed in the passage of the liquid; it slows down the flow rate of the liquid. The higher the flow rate, the more the level upstream of the obstacle will rise. With a calibrated obstacle, it is then possible to calculate the flow rate as a function of the liquid level measured upstream of the obstacle.

In order to measure the height of liquid upstream of the obstacle, a differential pressure measurement is used. Among the differential pressure sensors available on the market, it is possible in particular to use sensors that make it possible to measure low pressure values.

However, in order to reach this pressure level with a height of the cryogenic fluid, a height of the order of 300 mm has to be obtained. For this reason, it is advantageous to orient the spillway in the vertical direction so that it allows the creation of a high height of liquid, and that the differential pressure measurement is therefore also quite high.
2. Measurement of the flow rate of the subcooled liquid phase with a calibrated orifice: when the cryogenic fluid is subcooled, then the flow rate is measured using a calibrated orifice situated upstream or downstream of the spillway.

The liquid passes through the calibrated orifice and generates a pressure difference. By calculation, it is then possible to obtain the flow rate of the subcooled cryogenic fluid.

It will be noted here that this flow rate measurement system does not operate when the fluid is not subcooled. When it is saturated (or at equilibrium), the presence of gas in the liquid distorts the measurement, the measured pressure variation generates more two-phase. The measured pressure difference is not representative of the quantity of cryogenic fluid passing through the calibrated orifice. It is therefore necessary to know at any time the state of the cryogenic fluid, subcooled or not.
3. Measurement of the state of subcooling of the cryogenic fluid (determination of the state of the cryogenic fluid: subcooled or gas-liquid equilibrium): in order to know the state of the evaluated cryogenic fluid, the state of subcooling of the cryogenic fluid of which it is desired to measure the flow rate is measured.

To this end, the level of liquid present downstream of the spillway is measured. When this level is zero, the cryogenic fluid is not subcooled, whereas otherwise, the cryogenic fluid is subcooled:
Case No 1: If the sensor measuring the height of liquid in the apparatus (delta P2, downstream of the spillway) indicates a value that is almost zero, the fluid therefore has a gas phase and a liquid phase. The sensor measuring the pressure difference on the calibrated orifice (Delta P3) will also indicate a non-zero value (gas+liquid).
Case No 2: If the sensor measuring the height of liquid in the apparatus (ΔP2, downstream of the spillway) indicates a non-zero value, the fluid therefore has only a liquid phase. The sensor measuring the pressure difference on the calibrated orifice (ΔP3) will indicate a value representative of the flow rate of pure liquid.

In order to reliably detect whether the fluid is in case No. 1 or in case No. 2, a measurement is taken of the pressure difference in a second volume downstream of the spillway (ΔP2) as seen above. This volume is either filled with gas (case No. 1) or filled with liquid (case No. 2), because of the difference in density between liquid and gas phases, and thus makes it possible to define whether the fluid is pure liquid or a two-phase fluid.

And when ΔP3 is negative, this means that the fluid flow is reversed (from downstream to upstream): In this case, this flow is neutralized and not taken into account by the flowmeter. The error is thus minimized.
4. According to an advantageous embodiment of the invention, what can be called a “spillway with a plurality of slots” is implemented.

As mentioned above in the description of the prior art (U.S. Pat. No. 5,679,905), one of the critical points of such prior spillways resides in the accuracy of manufacture of their V-shaped slot. In order for the measurement to be accurate, the geometry of this V-shaped slot has to be perfectly controlled. In the case of a slot with a fixed width (not V-shaped), it is important for this slot to keep a constant width over its entire length. In practice, with the constraints associated with the construction techniques, it is very difficult to ensure that this slot has a constant width.

In this context, it is proposed according to the present invention to make this slot in a plurality of portions, and therefore, as it were, to implement a spillway with a plurality of slots, each segment having a short length making it possible to more surely retain a constant width.

The combination of all these slot sections forms the equivalent of a slot of constant width over the entire height. The high point of one slot corresponds exactly to the low point of the next. There is no overlap.
5. Calculation of an estimate of the two-phase content: by virtue of the system described above, it is possible, as has been understood, to measure the liquid phase regardless of the conditions, but it is possible to go further and carry out calculations based on the two measurements (via spillway and calibrated orifice) and then estimate the two-phase content. This content makes it possible to determine the gaseous phase and thus to refine the measurement of the total fluid flow rate.

The advantages of the flowmeter proposed according to the present invention can be summarized as follows:
a moderate cost;
a measurement offering very correct accuracy (typically 2%);
a system that cannot give rise to an erroneous measurement when the flow rate is zero or slightly negative and the cryogenic fluid is boiling in the flowmeter;
ease of installation;
it provides reliable measurements when the gas content in the fluid varies from 0 to 100%, the system even making it possible to measure the flow rate when the liquid is subcooled.

### BRIEF DESCRIPTION OF THE DRAWING

For a further understanding of the nature and objects for the present invention, reference should be made to the following detailed description, taken in conjunction with the accompanying drawings, in which like elements are given the same or analogous reference numbers and wherein:

FIG. 1 is a schematic representation of one embodiment of the present invention.

### DETAILED DESCRIPTION OF THE PREFERRED EMBODIMENTS

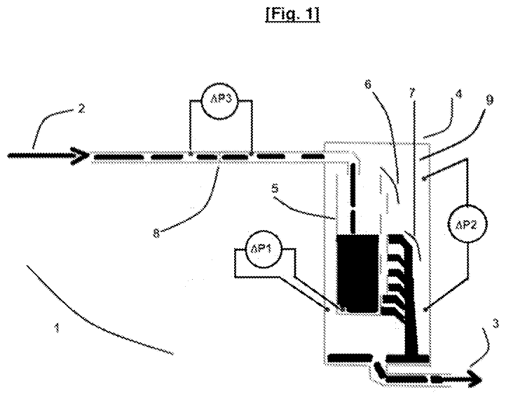

In summary, the flowmeter proposed here operates according to the following operating principle, which is explained in conjunction with the appended FIG. 1:
use of a flow rate measurement using a spillway for the liquid phase when the fluid is two-phase, the level being measured by virtue of the differential pressure ΔP1, where ΔP1 is the measurement of the pressure difference between the bottom of the reservoir 5 and the internal atmosphere of the apparatus. This makes it possible to deduce therefrom the height of liquid in the reservoir and subsequently the flow rate 7 passing through the slots 6.
use of a flow rate measurement via a calibrated orifice (8) and a differential pressure measurement ΔP3 for the gas phase when the fluid is 100% gaseous, for the liquid phase when the fluid is 100% liquid (subcooled) and to correct the liquid flow rate measured by the spillway when the fluid is two-phase. In other words, ΔP3 is measured on each side of a calibrated orifice, and this makes it possible to take a measurement of quality of the flow rate when the cryogen is 100% gaseous or 100% liquid (subcooled).
it can therefore be seen in FIG. 1 that the system is made up of a reservoir 5 that is provided with a segmented slot (several segments of slots 6). These slots represent the spillway.
a differential pressure measurement ΔP2 is considered, in order to deduce therefrom whether liquid is present downstream of the spillway in order to determine the state of the fluid (gaseous, two-phase or subcooled). This measurement indicates whether or not there is liquid flooding downstream of the spillway, this flooding possibly being due to the subcooled state of the cryogenic fluid or to the existence of a flow in the opposite direction.

Specifically, in normal operation, this ΔP2 carries out a measurement that is close to zero, in other words there is virtually no pressure difference between these two points in the gaseous phase.

By contrast, when the liquid cryogen (for example liquid nitrogen) arrives subcooled, the whole system will be filled with liquid, there will then be liquid in the whole of the apparatus (9).

In the latter case, according to the invention, the algorithm for calculation of the flow rate will switch over to the measurement using the calibrated orifice (ΔP3), which will operate quite correctly in the case of a subcooled liquid.

In this case, this situation will be detected by the appearance of a significant value of ΔP2, and thus when ΔP2 moves away from zero, there is a switch over to the mode of flow rate measurement using the calibrated orifice (ΔP3) and vice versa.

As will be explained below, in summary, in the case of a two-phase liquid, formulae are used that make it possible to calculate the gas content with ΔP1 and ΔP3 as input data. Subsequently, this gas content is used to correct the flow rate measurement obtained by the spillway.

Advantageously, the temperature of the fluid may also be measured in order to deduce its density therefrom. By virtue of this density, it will then be possible to refine the flow rate calculations related to the measurements of ΔP: ΔP1 of the spillway and ΔP3 of the calibrated orifice.

A summary is given of the nomenclature of the elements present in FIG. 1 illustrating one of the embodiments of the invention:
1: the flowmeter for cryogenic fluids
2: the fluid entering the device, of which the flow rate is to be measured
3: the fluid leaving the device and directed downstream
4: apparatus, boiler assembly
5: the reservoir upstream of the spillway
6: the slots in a vertical wall of the reservoir 5 (spillway)
7: the flow of liquid escaping through the slots 6
8: a calibrated orifice (providing the pressure difference ΔP3)
9: volume inside the apparatus

The embodiment presented in the appended FIG. 1 was used to implement the tests explained below, which gave very positive results.

Implementation with liquid nitrogen, tests carried out under various pressure conditions (from 1 to 3 barg) and various two-phase contents (from 0 to 100% gas).

A test was carried out with subcooled liquid nitrogen.

Of course, the flowmeter is adaptable, without difficulty, to other cryogenic fluids; it is sufficient to modify the cross section of the slots and the diameter of the calibrated orifice.

Overall, these tests show an accuracy of the order of +/−2% of the full measurement scale, which amounts to 3000 kg/h.

The experimental results are collated in Tables 1 and 2 below.

Table 1 shows the calculation logic used here.

Table 2 presents the various situations that can be encountered in the measurement of the flow rate, and by applying the logic set out in Table 1, a consistent measurement of the flow rate is obtained.

All the pressures shown in the table are ΔP.

The formulae of the functions fi used are as follows:

$$Formula for f 1 :$$

$$gaseous fluid flow rate ( kg . s - 1 ) = C ( discharge coefficient ) \times E ( approach velocity coefficient ) \times Epsilon ( expansion coefficient ) \times Pi \times ( calibrated orifice diameter squared ) \text{} / 4 \times ( root 2 ) \times ( root of the gaseous gas density ) \times ( root Δ P 3 )$$

$$Formula for liquid phase f 2 :$$

$$flow rate of the liquid phase of the two - phase gas = density of the liquid gas \times coefficient k \times width of the straight vertical slot \times ( root 2 ) \times ( root g ( root 9.81 gravity of the Earth ) ) \times height of liquid in the spillway to the power of 1.5$$

with height of liquid in the spillway=ΔP1/density of the liquid gas/g (9.81 gravity of the Earth), k being a fixed coefficient specific to each apparatus.
formula for total f2 (gaseous and liquid phases of the two-phase gas)=mathematical solution of the following equations

$$liquid mass flow rate = liquid phase f 2 calculated above$$

$$total flow rate = liquid mass flow rate f 2 + gas mass flow rate f 2$$

$$total mean density = ( liquid phase mass + gas phase mass ) \text{} / ( liquid phase volume + gas phase volume )$$

$$total f 2 : total mass flow rate ( kg . s - 1 ) = C ( discharge coefficient ) \times E ( approach velocity coefficient ) \times Epsilon ( expansion coefficient ) \times Pi \times ( calibrated orifice diameter to the power of 2 ) \text{} / 4 \times ( root 2 ) \times ( root of the total mean density ) \times ( root Δ P 3 )$$

$$with mean density = liquid phase density \times ( 1 - f 4 ) + gas phase density \times f 4$$

$$total f 3 : pure liquid gas flow rate ( kg . s - 1 ) = C ( discharge coefficient ) \times E ( approach velocity coefficient ) \times Epsilon ( expansion coefficient ) \times Pi \times ( calibrated orifice diameter to the power of 2 ) \text{} / 4 \times ( root 2 ) \times ( root of the liquid gas density ) \times ( root Δ P 3 )$$

formula for f4: In order to calculate f4, a mathematical solution of the equations presented for the calculation of f2 is performed.

TABLE 1

| | | | flow rate | |
|---|---|---|---|---|
| Condition 1 | Condition 2 | Condition 3 | measurement | Two-phase content |
| If ΔP3 >= 0 | If ΔP2 > 0 | | f3(ΔP3) (flow rate of | 0 |
| | | | a calibrated orifice | |
| | | | with pure liquid) | |
| | If ΔP2 =< 0 | If ΔP1 > 0 | f2(ΔP1, f4) (flow | f4(ΔP1, ΔP3) (two- |
| | | | rate of a spillway | phase content |
| | | | with pure liquid + | calculated with ΔP1 |
| | | | correction for the | and ΔP3) |
| | | | gas phase) | |
| | | If ΔP1 =< 0 | f1(ΔP3) (flow rate of | 100 |
| | | | a calibrated orifice | |
| | | | with pure gas) | |
| If ΔP3 < 0 | | | 0 | 0 |

TABLE 2

| | State of | | | | | measurement | Estimation of |
|---|---|---|---|---|---|---|---|
| Flow | the cryo | % | Delta | Delta | Delta | of the | the two-phase |
| direction | fluid | gas | P1 | P2 | P3 | flow rate | content |
| Normal | Gaseous | 100 | 0 | 0 | >0 | f1(ΔP3) | 100% |
| Normal | two-phase | 0 to 100 | >0 | 0 | >0 | f2(ΔP1, f4) | f4(ΔP1, ΔP3) |
| Normal | subcooled | 0 | 0 | >0 | >0 | f3(ΔP3) | 0% |
| Opposite | Gaseous | 100 | 0 | 0 | <0 | 0 measurement | 0% measurement |
| | | | | | | error | error |
| Opposite | two-phase | 0 to 100 | 0 | >0 | <0 | 0 measurement | 0% measurement |
| | | | | | | error | error |
| opposite | subcooled | 0 | 0 | >0 | <0 | 0 measurement | 0% |
| | | | | | | error | |

The examples set out below are based on measurements taken on an item of equipment in accordance with that described in the context of FIG. 1, with a flowmeter equipped with a spillway with a slot 2 mm wide and a calibrated orifice 8 20 mm in diameter. The fluid used was liquid nitrogen at a pressure of 2 barg.

$$Situation n °1 : no gas circulation :$$

$$Δ P 1 = 0$$

$$Δ P 2 = 0$$

$$Δ P 3 = 0$$

| Condition 1 | Condition 2 | Condition 3 | flow rate measurement | Two-phase content |
|---|---|---|---|---|
| If | If ΔP2 > 0 | | f3(ΔP3)(flow rate of a | |
| ΔP3 >= 0 | | | calibrated orifice with | |
| | | | pure liquid) | |
| | If | If ΔP1 > 0 | f2(ΔP1, f4) (flow rate of | f4(ΔP1, ΔP3) (two- |
| | ΔP2 =< 0 | | & spillway with pure | phase content |
| | | | liquid + correction for | calculated with AP1 |
| | | | the gas phase) | and ΔP3) |
| | | | f1(ΔP3) (flow rate of | 100% |
| | | | a calibrated orifice | |
| | | | pure gas) | |
| | | | 0 kg/h | |
| If ΔP3 < 0 | | | 0 | 0 |

$$Situation n °2 : pure gas during cooling of the apparatus :$$

$$Δ P 1 = 0$$

$$Δ P 2 = 0$$

$$Δ P 3 = 52 mbar$$

| Condition 1 | Condition 2 | Condition 3 | flow rate n | Two-phase con |
|---|---|---|---|---|
| ΔP3 >= 0 | If ΔP2 > 0 | | f3(ΔP3) (flow rate of a | 0 |
| | | | calibrated orifice with | |
| | | | pure liquid) | |
| | If | If ΔP1 > 0 | f2(ΔP1, f4) (low rate of | f4(ΔP1, ΔP3) (two- |
| | ΔP2 =< 0 | | a spillway with pure | phase content |
| | | | liquid + correction for | calculated with ΔP1 |
| | | | the gas phase) | and ΔP3) |
| | | If | f1(ΔP3) (flow rate of | 100% gas |
| | | ΔP1 =< 0 | a calibrated orifice with | |
| | | | pure gas) | |
| | | | 301 kg/ | |
| If ΔP3 < 0 | | | 0 | 0 |

$$Situation n °3 : two - phase gas during standard operation :$$

$$Δ P 1 = 16$$

$$Δ P 2 = 0$$

$$Δ P 3 = 18 mbar$$

| Condition 1 | Condition 2 | Condition 3 | flow rate measurement | Two-phase content |
|---|---|---|---|---|
| If | If ΔP2 > 0 | | f3(ΔP3) (flow rate of a | 0 |
| ΔP3 >= 0 | | | calibrated orifice with | |
| | | | pure liquid) | |
| | If | If AP1>0 | f2(ΔP1, f4)(flow rate of | f4(ΔP1, ΔP3) (two- |
| | AP2 =< 0 | | a spillway with pure | phase content |
| | | | liquid + correction for | calculated with ΔP1 |
| | | | the gas phase | and ΔP3) |
| | | | 863 kg/h | 2% gas |
| | If | | f1(ΔP3) (flow rate of | 100 |
| | ΔP1 =< 0 | | a calibrated orifice with | |
| | | | pure gas | |
| If ΔP3 < 0 | | | 0 | |

$$Situation n °4 : subcooled liquid gas :$$

$$Δ P 1 = 16$$

$$Δ P 2 = 5$$

$$Δ P 3 = 15 mbar$$

$$Situation n °5 : gas circulation in the opposite direction :$$

$$Δ P 1 = 1$$

$$Δ P 2 = 8$$

$$Δ P 3 = - 11 ( negative )$$

| Condition 1 | Condition 2 | Condition 3 | flow rate measurement | Two-phase content |
|---|---|---|---|---|
| If | If ΔP2 > 0 | | f3(ΔP3) (flow rate of a | 0 |
| ΔP3 >= 0 | | | calibrated orifice with | |
| | | | pure liquid | |
| | If | If ΔP1 > 0 | f2(ΔP1, f4)(flow rate of | f4(ΔP1, ΔP3) (two- |
| | ΔP2 =< 0 | | a spillway with pure | phase content |
| | | | liquid + correction for | calculated with ΔP1 |
| | | | the gas phase) | and ΔP3) |
| | | If | f1(AP3) (flow rate of | 100 |
| | | ΔP1 =< 0 | a calibrated orifice with | |
| | | | pure gas) | |
| If ΔP3 < 0 | | | 0 kg/h | 0% gas |

The present invention then relates (the numerical references can be found in the appended FIGURE) to a flowmeter for liquid/gas cryogenic two-phase fluids, comprising:
An inlet pipe for the fluid of which the flow rate is to be measured, in the flowmeter, which pipe is provided with a calibrated orifice;
A vertical reservoir (5), which reservoir is surrounded by an apparatus (4), into which reservoir said pipe opens, the wall of the reservoir being provided with a plurality of slots for outflow of the fluid (6-“spillway” system), from the reservoir (5) toward the interior space (9) inside the apparatus surrounding the reservoir (5);
Pressure sensors making it possible to measure the following pressure differences:
   A pressure difference (ΔP3) between upstream and downstream of the calibrated orifice
   A pressure difference (ΔP1) between the bottom of the reservoir (5) and the atmosphere surrounding the reservoir (9) within the interior space (9) within the apparatus;
   A pressure difference (ΔP2) existing between two points located in the space surrounding the reservoir (5) within the interior space (9), making it possible to deduce the height of liquid downstream of the reservoir, in order to determine the state of the fluid (gaseous, two-phase or subcooled), and giving the level of liquid flooding downstream of the reservoir.
a data acquisition and processing system, which is able to carry out the following evaluations:
a. determination of the information on the state of the incoming fluid: gaseous, two-phase or subcooled, from the pressure difference datum ΔP2;
b. depending on this state information, the determination of said flow rate using either the pressure differential ΔP3 when the fluid is 100% gaseous or 100% liquid (subcooled), or the pressure differential ΔP1 that makes it possible to deduce the height of liquid in the reservoir and subsequently the flow rate of fluid passing through the slots.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1. (canceled)

2. A flowmeter for liquid/gas cryogenic two-phase fluids, comprising:
an inlet pipe configured for the two-phase fluid of which the flow rate is to be measured in the flowmeter, the inlet pipe comprising a calibrated orifice,
a vertical reservoir surrounded by an apparatus, wherein the inlet pipe opens into the vertical reservoir, the vertical reservoir comprising a wall provided with a plurality of slots for outflow of the two-phase fluid, thereby forming a spillway system from the vertical reservoir toward an interior space inside the apparatus surrounding the reservoir,
at least one pressure sensor configured to measure the following pressure differences:
a first pressure difference between the bottom of the vertical reservoir and an atmosphere surrounding the vertical reservoir within the interior space within the apparatus,
a second pressure difference existing between two points located in the space surrounding the vertical reservoir within the interior space, configured to deduce the height of liquid downstream of the vertical reservoir, thereby determining the state of the two-phase fluid to be gaseous, two-phase or subcooled, and determining a level of liquid flooding downstream of the vertical reservoir, and
a third pressure difference between upstream and downstream of the calibrated orifice,
a data acquisition and processing system, configured to carry out the following evaluations:
determination of the information on the state of the incoming two-phase fluid to be gaseous, two-phase or subcooled, from the second pressure difference.
depending on this state information, the determination of a flow rate using either the third pressure differential when the fluid is 100% gaseous or 100% liquid (subcooled), or the first pressure differential configured to deduce the height of liquid in the vertical reservoir and subsequently the flow rate of two-phase fluid passing through the slots.
